(19) United States
(12) Patent Application Publication
(10) Pub. No.: US 2015/0345178 A1
(43) Pub. Date: Dec. 3, 2015

(54) CYLINDER LOCK DEVICE

(71) Applicants: KABUSHIKI KAISHA TOKAI RIKA DENKI SEISAKUSHO, Aichi (JP); TOYOTA JIDOSHA KABUSHIKI KAISHA, Toyota-shi (JP)

(72) Inventors: Tomohide KUSHIDA, Aichi (JP); Jun MIZUMOTO, Aichi (JP); Yoshiki ISHIKAWA, Toyota-shi (JP)

(21) Appl. No.: 14/724,019

(22) Filed: May 28, 2015

(30) Foreign Application Priority Data
Jun. 2, 2014 (JP) 2014-114069

(51) Int. Cl. E05B 27/00

(52) U.S. Cl. CPC E05B 27/001

(57) ABSTRACT

A cylinder lock device includes a body, a rotor rotatably arranged inside the body, a first sleeve rotatably arranged between the body and the rotor, a rotatable holder lever arranged to face a side of the rotor opposite to the key insertion side, a second sleeve that is arranged between the rotor and the holder lever, is axially movable relative to the holder lever and rotates in conjunction with the holder lever, and a biasing member pressing the second sleeve toward the rotor so as to engage the second sleeve with the rotor, the biasing member applying a force in a circumferential direction of the second sleeve or the holder lever. The body includes a region that serves both as a stopper against an end portion of the biasing member and as a contact portion for restricting the second lever or the holder lever from moving in a rotation direction.

The present application is based on Japanese patent application No. 2014-114069 filed on Jun. 2, 2014, the entire contents of which are incorporated herein by reference.

### BACKGROUND OF THE INVENTION

1. Field of the Invention

The invention relates to a cylinder lock device configured such that only a rotor is rotated relative to a body when an incorrect key or a foreign object such as screwdriver is inserted.

2. Description of the Related Art

A cylinder lock device for, e.g., a vehicle door, etc., is known, in which a rotor is rotatably arranged inside a cylindrical body and has a key insertion hole formed to extend in an axial direction (see, e.g., JP-A-2007-239242). When a correct key is inserted, each tumbler is disengaged from a sleeve (which corresponds to a first sleeve in the present invention), allowing the rotor and the sleeve to be rotated independently. By the subsequent rotation of the key, a clutch member (which corresponds to a second sleeve in the invention) and a lever member (which corresponds to a holder lever) are rotated together with the rotor and the door is thereby locked/unlocked.

Meanwhile, in case that an incorrect key or a foreign object such as screwdriver is inserted, a freewheel mechanism functions to allow only the rotor and the sleeve to rotate relative to the body. In this cylinder lock device, when the rotor is rotated by a key other than the correct key, the rotor is disengaged from the clutch member to make the rotor and the sleeve rotatable relative to the body and the rotation is thus not transmitted to the lever member.

### SUMMARY OF THE INVENTION

In the cylinder lock device provided with such a freewheel mechanism, a spring is required to move the rotor, the sleeve, the clutch member and the lever member back to the key neutral position. In addition, since the rotor is not engaged with the lever member when the freewheel mechanism is in operation, a restricting portion is also required to restrict the clutch member and the lever member from moving in a rotation direction. Furthermore, in the conventional configuration, a stopper for the spring is separately provided from the restricting portion for restricting the clutch member and the lever member from rotating and it is thus necessary to increase the size in a radial direction.

It is an object of the invention to provide a cylinder lock device that achieves reduction in radial size thereof.

(1) According to one embodiment of the invention, a cylinder lock device comprises: a body;

a rotor rotatably arranged inside the body;

a first sleeve rotatably arranged between the body and the rotor and comprising a key insertion hole;

tumblers that are provided on the rotor so as to be movable in a radial direction, are engaged with the first sleeve by being pressed radially outward and are disengaged from the first sleeve when a correct key is inserted into the key insertion hole;

a rotatable holder lever arranged to face a side of the rotor opposite to the key insertion side;

sliding members that are arranged between the first sleeve and the body and move in an axial direction toward the holder lever when the first sleeve is relatively rotated by a predetermined angle relative to the body;

a second sleeve that is arranged between the rotor and the holder lever, is axially movable relative to the holder lever and rotates in conjunction with the holder lever, and is disengaged from the rotor when the sliding members move toward the holder lever; and

a biasing member pressing the second sleeve toward the rotor so as to engage the second sleeve with the rotor, the biasing member applying a force in a circumferential direction of the second sleeve or the holder lever,

wherein the body comprises a region that serves both as a stopper against an end portion of the biasing member and as a contact portion for restricting the second sleeve or the holder lever from moving in a rotation direction.

In the above embodiment (1) of the invention, the following modifications and changes can be made.

(i) The biasing member comprises a coil spring, and end portions of the biasing member comprise both ends of the coil spring.

(ii) The contact portion is a notch provided on the second sleeve at a predetermined circumferential position.

(2) According to another embodiment of the invention, a cylinder lock device comprises:

a body;

a rotor rotatably arranged inside the body;

a first sleeve rotatably arranged between the body and the rotor and comprising a key insertion hole;

a rotatable holder lever arranged to face a side of the rotor opposite to the key insertion side;

sliding members that are arranged between the first sleeve and the body and move in an axial direction toward the holder lever when the first sleeve is relatively rotated by a predetermined angle relative to the body;

a second sleeve that is arranged between the rotor and the holder lever, is axially movable relative to the holder lever and rotates in conjunction with the holder lever, and is disengaged from the rotor when the sliding members move toward the holder lever; and

a biasing member pressing the second sleeve toward the rotor so as to engage the second sleeve with the rotor, the biasing member applying a force in a circumferential direction of the second sleeve or the holder lever,

wherein the body comprises a region that serves both as a stopper against an end portion of the biasing member and as a contact portion for restricting the second lever or the holder lever from moving in a rotation direction.

In the above embodiment (2) of the invention, the following modifications and changes can be made.

(iii) The region comprises a protrusion on the body.

(iv) The rotor is engaged with the second sleeve so as to rotate the holder lever according to a rotation of a correct key when the correct key is inserted into the key insertion hole.

(v) The first sleeve allows disengagement between the rotor and the second sleeve so as not to rotate the holder lever according to a rotation of an incorrect key when the incorrect key is inserted into the key insertion hole.

### Effects of the Invention

According to one embodiment of the invention, a cylinder lock device that achieves reduction in radial size thereof

### BRIEF DESCRIPTION OF THE DRAWINGS

Next, the present invention will be explained in more detail in conjunction with appended drawings, wherein:

FIG. 1 is an exploded perspective view showing a cylinder lock device in an embodiment of the invention;

FIG. 2A is a side view showing the cylinder lock device in the embodiment of the invention;

FIG. 2B is a cross sectional view taken on line B-B in FIG. 2A;

FIG. 2C is a cross sectional view taken on line A-A in FIG. 2A; and

FIG. 3 is an enlarged detail view of FIG. 2B.

### DESCRIPTION OF THE PREFERRED EMBODIMENT

An embodiment of the invention will be specifically described below in conjunction with the appended drawings.

Configuration of Cylinder Lock Device

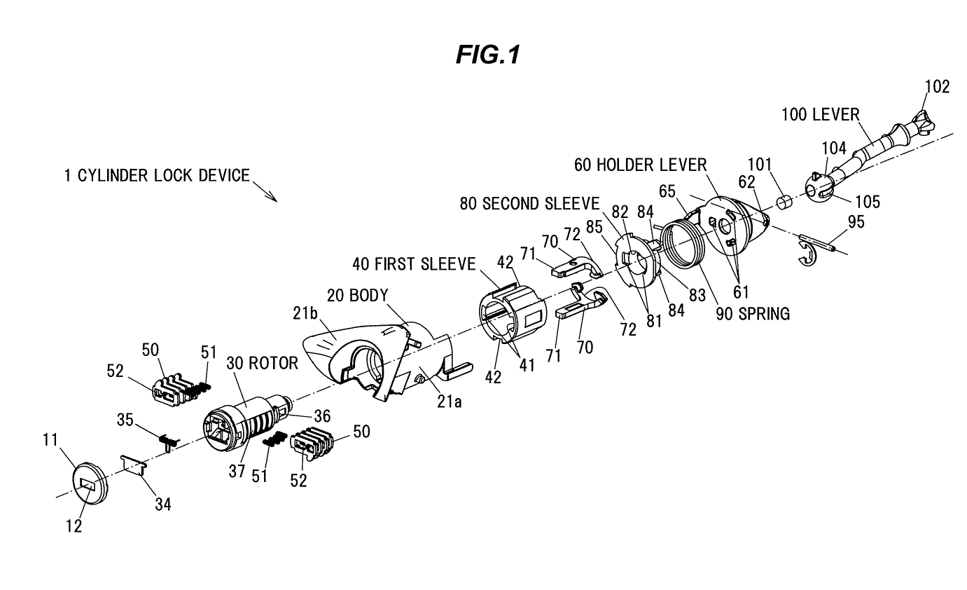

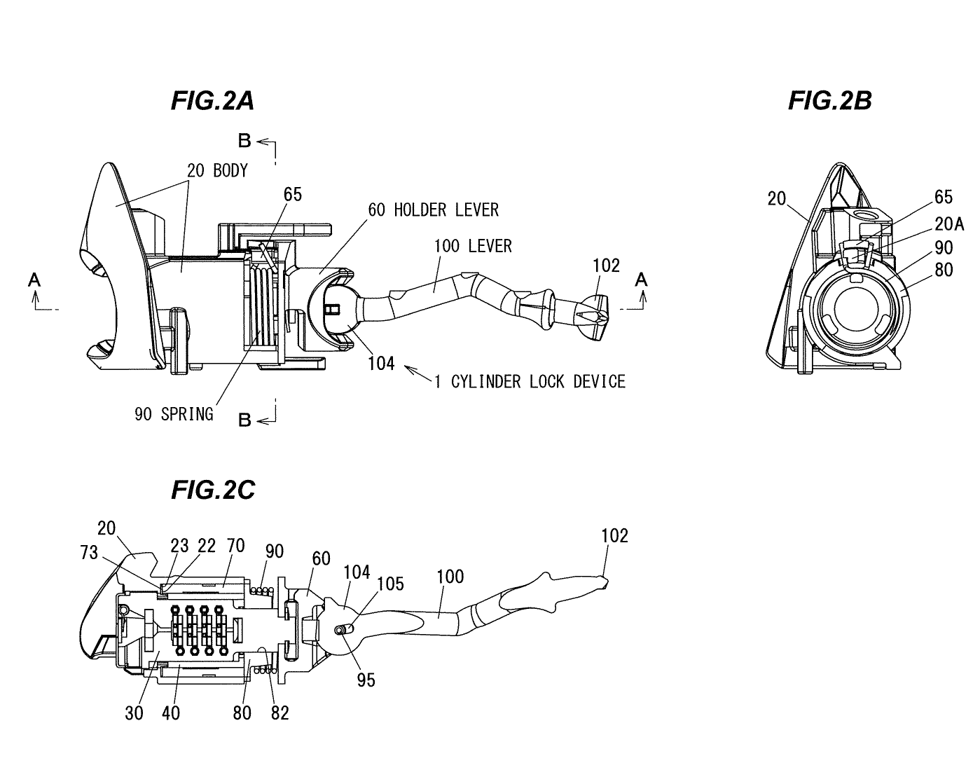

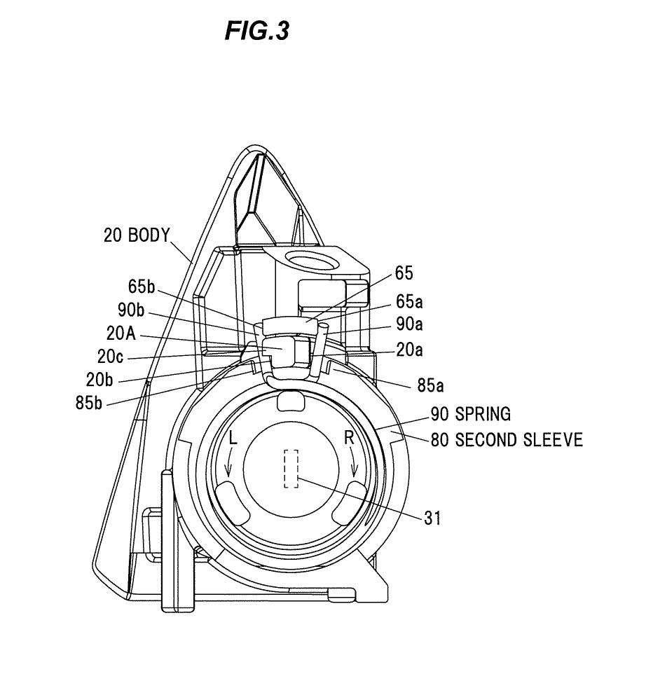

FIG. 1 is an exploded perspective view showing a cylinder lock device in the embodiment of the invention. FIG. 2A is a side view showing the cylinder lock device in the embodiment of the invention. FIG. 2B is a cross sectional view taken on a line B-B in FIG. 2A. FIG. 2C is a cross sectional view taken on a line A-A in FIG. 2A. FIG. 3 is an enlarged detail view of FIG. 2B.

As shown in FIG. 1, a cylinder lock device 1 has a body 20 provided with a cylindrical portion and attached to a vehicle door, etc., a rotor 30 rotatably arranged inside the body 20, a first sleeve 40 rotatably arranged between the body 20 and the rotor 30, tumblers 50 provided on the rotor 30 so as to be movable in a radial direction, and a rotatable holder lever 60 arranged to face a side of the rotor 30 opposite to the key insertion side. An end portion of the rotor 30 on the key insertion side is covered with a rotor cover 11. In the cylinder lock device 1, when a correct (or proper) key is inserted into the rotor 30 and is rotated, a second sleeve 80 and the holder lever 60 rotate together with the rotor 30. Meanwhile, the cylinder lock device 1 is provided with a disengagement mechanism by which the rotor 30 is disengaged from the second sleeve 80 such that only the rotor 30 rotates relative to the holder lever 60 when the rotor 30 is forcedly rotated by an incorrect key or a screwdriver, etc., i.e., a so-called freewheel method is adopted. In other words, the rotor 30 and the second sleeve 80 provide a clutch mechanism.

In detail, as shown in FIG. 1, the cylinder lock device 1 is provided with slide bars 70 as sliding members arranged between the first sleeve 40 and the body 20, the second sleeve 80 arranged between the rotor 30 and the holder lever 60, and a spring 90 pressing the second sleeve 80 toward the rotor 30 such that the second sleeve 80 comes into contact with the rotor 30, all of which work together to realize a freewheel mechanism.

The body 20 is composed of a cylindrical portion 21a and a front portion 21b. The cylindrical portion 21a houses the rotor 30 and the first sleeve 40, etc. The front portion 21b is a portion to be exposed to a surface a vehicle door, etc., when installing the device. The body 20 is attached and fixed in a state that the cylindrical portion 21a is inserted into an insertion hole of a vehicle door panel, etc., and the front portion 21b is exposed to the surface of the door panel.

The rotor 30 is in a substantially cylindrical shape and has a key insertion hole 31 formed to extend in an axial direction. As shown in FIG. 1, the key insertion side of the rotor 30 is covered with the rotor cover 11 in the middle of which a key insertion hole 12 is formed. A shutter member 34 is provided behind the rotor cover 11 and covers the key insertion hole 12 when the key is not inserted. The shutter member 34 is pressed by a shutter spring 35 in a direction of closing the key insertion hole 12.

As shown in FIG. 1, raised portions 36 engageable with recessed portions 81 of the second sleeve 80 are formed on an outer peripheral surface of the rotor 30 on the opposite side to the key insertion side. Two raised portions 36 extending in a circumferential direction are formed at intervals of about 180°. In addition, grooves 37 are formed on the rotor 30 to guide the tumblers 50 in a radial direction. In the present embodiment, eight tumblers 50 in total are alternately arranged and eight grooves 37 are formed correspondingly.

Each of the grooves 37 houses a tumbler spring 51 and each tumbler 50 is pressed radially outward by each tumbler spring 51. Engaging grooves 41 to be engaged with a radially outer end portion of each tumbler 50 are formed on the first sleeve 40 and the rotor 30 rotates integrally with the first sleeve 40 when the tumblers 50 pressed radially outward are engaged with the engaging grooves 41. A hole 52 matching a correct key is formed on each tumbler 50. Each tumbler 50 moves in a radial direction along a grove shape of the key inserted into the rotor 30. When the correct key is inserted, all tumblers 50 are separated and disengaged from the first sleeve 40, thereby allowing the rotor 30 and the first sleeve 40 to be rotated independently.

As shown in FIG. 1, the first sleeve 40 is in a substantially cylindrical shape and has a pair of engaging grooves 41 which are formed on the side surface so as to extend in the axial direction. In addition, receiving grooves 42 are formed on the side surface of the first sleeve 40 and axially movably receive the slide bars 70. In the present embodiment, two slide bars 70 are provided and the engaging grooves 41 and the receiving grooves 42 are alternately arranged at intervals of about 90°.

The slide bars 70 are each formed in a substantially T-shape and is composed of an axially-extended portion 71 and a circumferentially-extended portion 72. The axially-extended portion 71 extends in an axial direction and is housed in the receiving groove 42. The circumferentially-extended portion 72 is formed at an end portion of the axially-extended portion 71 on the second sleeve 80 side so as to extend in a circumferential direction. Each slide bar 70 moves in an axial direction toward the holder lever 60 when the first sleeve 40 is relatively rotated by a predetermined angle relative to the body 20.

As shown in FIG. 2C, a level difference is formed on the inner surface of the body 20 to provide different inner diameters in the body 20, and an end face 73 of the axially-extended portion 71 of the slide bar 70 on the opposite side to the circumferentially-extended portion 72 comes into sliding contact with a sliding contact surface 22 of the level difference of the body 20. Recessed portions 23 are formed at predetermined positions on the sliding contact surface 22 which extends in a circumferential direction. Here, since the end face 73 of the slide bar 70 and both circumferential edges of the recessed portion 23 are inclined, each slide bar 70 is smoothly inserted/extracted into/from the recessed portion 23 when relatively moved in the circumferential direction. In other words, the cylinder lock device 1 is provided with a cam mechanism which has the sliding contact surface 22 formed on the body 20 and the end face 73 as a sliding contact portion which is formed on the slide bar 70 and comes into sliding contact with the sliding contact surface 22, and the cam mechanism moves the slide bar 70 toward the second sleeve 80 when the first sleeve 40 is relatively rotated relative to the body 20.

The circumferentially-extended portion 72 is in contact with the second sleeve 80 which is pressed by the spring 90. Thus, each slide bar 70, together with the second sleeve 80, is pressed toward the key insertion side. Due to this pressing force, each slide bar 70 is fitted to the recessed portion 23 of the body 20 in the initial state and, when the first sleeve 40 is relatively rotated relative to the body 20 from the initial state, each slide bar 70 is withdrawn from the recessed portion 23 against the pressing force and moves in the axial direction toward the holder lever 60. The axial movement of each slide bar 70 separates the second sleeve 80 from the rotor 30 and the raised portions 36 of the rotor 30 are thereby disengaged from the recessed portions 81 of the second sleeve 80. An end portion of the first sleeve 40 on the second sleeve 80 side is notched so as to correspond to the circumferentially-extended portions 72 of the slide bars 70, as shown in FIG. 1.

As shown in FIG. 1, the second sleeve 80 is in a substantially circular-disc shape and has a receiving hole 82 formed in the center to receive an end of the rotor 30. A cylindrical portion 83 is formed on the second sleeve 80 so as to extend toward the holder lever 60 and plural coupling portions 84 are formed to protrude from an end of the cylindrical portion 83. The coupling portions 84 are inserted into insertion holes 61 formed on the holder lever 60. This allows the second sleeve 80 to be axially movable relative to the holder lever 60.

Each of the recessed portions 81 is formed on a surface of the second sleeve 80 on the key insertion side at an inner rim of the receiving hole 82 (see FIG. 1). Thus, when each raised portion 36 is located at an angle from which the raised portion 36 does not fit to the recessed portion 81, each raised portion 36 comes into contact with the surface of the second sleeve 80 on the key insertion side and the rotor 30 can relatively rotate relative to the second sleeve 80. In other words, a portion of the second sleeve 80 except the recessed portions 81 comes into sliding contact with the raised portions 36 in a state that the second sleeve 80 is not engaged with the rotor 30. Thus, in the state that the rotor 30 is not engaged with the second sleeve 80, a pressing force applied to the second sleeve 80 from the spring 90 is received by the rotor 30.

As shown in FIG. 1, a notch 85 for restricting rotation of the body 20 is formed on the outer periphery of the second sleeve 80. Meanwhile, a protrusion 20A is formed on the body 20, as shown in FIG. 3. The protrusion 20A is formed to have a smaller width than the notch 85 of the second sleeve 80 and comes into contact with contact portions 85a and 85b in accordance with the rotation of the second sleeve 80, thereby restricting rotation of the second sleeve 80. The protrusion 20A is a region which also serves as a below-described stopper for the spring 90.

The second sleeve 80 is pressed by the spring 90 toward the rotor 30 in normal use, i.e., when a cylinder lock is operated by a correct key, and the notch 85 can pass through a notched groove (not shown) of the body 20. On the other hand, the second sleeve 80 moves toward the holder lever 60 by being pressed by the slide bars 70 during freewheel operation. In this state, the notch 85 can come into contact with the protrusion 20A of the body 20 in accordance with the rotation.

The spring 90 is a torsion coil spring as a biasing member and is composed of a coiled portion as a compression spring and end portions 90a and 90b each protruding in a radial direction. Thus, the spring 90 functions as a compression spring for pressing the second sleeve 80 toward the rotor 30 and also as a torsion spring for generating a pressing force in a circumferential direction.

As shown in FIGS. 1, 2A and 2B, the spring 90 is wound around the cylindrical portion 83 and the coupling portion 84 of the second sleeve 80 and, at the same time, is sandwiched between a surface of the second sleeve 80 on the holder lever 60 side and a surface of the holder lever 60 on the rotor 30 side.

In addition, as shown in FIG. 3, the end portion 90a of the spring 90 presses against and is stopped by a side surface 65a of a protrusion 65 of the holder lever 60 and the end portion 90b presses against and is stopped by a side surface 65b of a protrusion 65. In this state, the spring 90 is locked as a torsion spring preloaded with a predetermined force. Meanwhile, the protrusion 20A provided on the body 20 is arranged so as to be located between the end portions 90a and 90b of the spring 90. Here, the end portion 90b is stopped by an end portion 20c of the protrusion 20A and the spring 90 is thereby prevented from slipping off in an axial direction.

Meanwhile, as shown FIGS. 1 and 3, the second sleeve 80 is arranged such that the protrusion 20A of the body 20 is sandwiched between the contact portions 85a and 85b as sidewalls of the notch 85. Therefore, when the second sleeve 80 is rotated during freewheel operation, the contact portions 85a and 85b come into contact with contact ends 20a and 20b of the protrusion 20A and the second sleeve 80 is restricted from rotating.

As shown FIGS. 1, 2A and 2B, a coupling portion 62 of the holder lever 60 is coupled to a coupling portion 104 of a lever 100 by a pin 95. Rotation of the holder lever 60 is transmitted to the lever 100 and a connecting portion 102 formed at an end of the lever 100 is rotationally driven. The connecting portion 102 is connected to a door lock mechanism arranged in a door panel (not shown). The door lock mechanism is driven by rotation of the connecting portion 102 in conjunction with rotation of a key (the rotor 30) and the door is thereby locked or unlocked.

Operation of Cylinder Lock by Correct Key

When a correct key is inserted into the key insertion hole 31, the tumblers 50 are disengaged from the first sleeve 40, allowing the rotor 30 and the first sleeve 40 to be rotated independently. When the key is rotated in this state, the second sleeve 80 engaged with the rotor 30 rotates together with the holder lever 60 and the lever 100 is rotationally driven, thereby driving the door lock mechanism to lock or unlock the door.

In FIG. 3, door locking operation is performed by rotating a key in, e.g., an L-direction. When the correct key is inserted into the key insertion hole 31 and is rotated in the L-direction, the rotor 30, the second sleeve 80, the holder lever 60 and the lever 100 are rotated. The rotation direction of the locking operation is different between right-hand drive vehicle and left-hand drive vehicle. For example, the locking operation for a right-hand drive vehicle is performed in the L-direction as described above.

When the holder lever 60 is rotated in the L-direction, the end portion 90b of the spring 90 is rotated in the L-direction by the side surface 65b of the protrusion 65 of the holder lever 60. Meanwhile, the end portion 90a of the spring 90 comes into contact with and is stopped by the contact end 20a of the protrusion 20A which is now serving as a stopper. Thus, if the rotation operation is performed in the L-direction, a pressing force (restoring force) in a reverse direction (R-direction) to return to the neutral position shown in FIG. 3 acts in the circumferential direction of the rotor 30, the second sleeve 80 and the holder lever 60.

Although the second sleeve 80 is also rotated in the L-direction, the notch 85 passes through the notched groove (not shown) of the body 20 in normal use as previously described and the contact portion 85a of the second sleeve 80 does not come into contact with the contact end 20a of the protrusion 20A of the body 20.

When the door unlock operation is performed by rotating the key in the R-direction, all of the motions described above are performed in the opposite direction.

Operation of Cylinder Lock by Incorrect Key

If an incorrect key or a foreign object such as screwdriver is inserted into the key insertion hole 31, the tumblers 50 are not disengaged from the first sleeve 40 and the rotor 30 still rotates together with the first sleeve 40. When the key is rotated in this state, the first sleeve 40 together with the rotor 30 rotates relative to the body 20, the slide bars 70 move toward the holder lever 60 and the second sleeve 80 is then disengaged from the rotor 30. As a result, even when the key is rotated, only the rotor 30 and the first sleeve 40 rotate but the second sleeve 80 and the holder lever 60 do not rotate.

During freewheel operation, the second sleeve 80 and the holder lever 60 are not coupled to the rotor 30 in a rotation direction. However, since the second sleeve 80 is arranged such that the protrusion 20A of the body 20 is sandwiched between the contact portions 85a and 85b as sidewalls of the notch 85, the second sleeve 80 is restricted from rotating by contact of the contact portions 85a and 85b with the contact ends 20a and 20b of the protrusion 20A. As a result, the second sleeve 80 and the holder lever 60 are kept at the neutral position shown in FIG. 3.

### Effects of the Embodiment of the Invention

In the embodiment of the invention, the following effects are obtained.

(1) As shown in FIG. 3, the body 20 has the protrusion 20A which is formed to have a smaller width than the notch 85 of the second sleeve 80 and comes into contact with contact portions 85a and 85b in accordance with the rotation of the second sleeve 80 to restrict rotation of the second sleeve 80. The protrusion 20A is formed as a region which also serves as a stopper for restricting the spring 90 from rotating. Providing the region having two functions allows the cylinder lock device to be downsized in a radial direction.

(2) The downsizing of the cylinder lock device in the radial direction means that the cylindrical portion 21a of the body 20 has a small diameter, which allows the diameter of the insertion hole of the door panel, etc., to be reduced. As such, it is possible to meet the needs of downsizing the cylinder lock device in the radial direction.

(3) The downsizing of the cylinder lock device in the radial direction provides effects such as improvement in degrees of freedom in design around a door handle of the door panel.

Although the cylinder lock device 1 for locking/unlocking a vehicle door has been described as an example of the embodiment, the cylinder lock device 1 may be configured to lock/unlock, e.g., house doors or drawers, etc.

Although the typical embodiment and illustrated examples of the invention have been described, the invention according to claims is not to be limited thereto. It should be therefore noted that all combinations of the features described in the embodiment and illustrated examples are not necessary to solve the problem of the invention.

What is claimed is:

1. A cylinder lock device, comprising:
a body;
a rotor rotatably arranged inside the body;
a first sleeve rotatably arranged between the body and the rotor and comprising a key insertion hole;
tumblers that are provided on the rotor so as to be movable in a radial direction, are engaged with the first sleeve by being pressed radially outward and are disengaged from the first sleeve when a correct key is inserted into the key insertion hole;
a rotatable holder lever arranged to face a side of the rotor opposite to the key insertion side;
sliding members that are arranged between the first sleeve and the body and move in an axial direction toward the holder lever when the first sleeve is relatively rotated by a predetermined angle relative to the body;
a second sleeve that is arranged between the rotor and the holder lever, is axially movable relative to the holder lever and rotates in conjunction with the holder lever, and is disengaged from the rotor when the sliding members move toward the holder lever; and
a biasing member pressing the second sleeve toward the rotor so as to engage the second sleeve with the rotor, the biasing member applying a force in a circumferential direction of the second sleeve or the holder lever,
wherein the body comprises a region that serves both as a stopper against an end portion of the biasing member and as a contact portion for restricting the second sleeve or the holder lever from moving in a rotation direction.

2. The cylinder lock device according to claim 1, wherein the biasing member comprises a coil spring, and end portions of the biasing member comprise both ends of the coil spring.

3. The cylinder lock device according to claim 1, wherein the contact portion is a notch provided on the second sleeve at a predetermined circumferential position.

4. A cylinder lock device, comprising:
a body;
a rotor rotatably arranged inside the body;
a first sleeve rotatably arranged between the body and the rotor and comprising a key insertion hole;
a rotatable holder lever arranged to face a side of the rotor opposite to the key insertion side;
sliding members that are arranged between the first sleeve and the body and move in an axial direction toward the holder lever when the first sleeve is relatively rotated by a predetermined angle relative to the body;
a second sleeve that is arranged between the rotor and the holder lever, is axially movable relative to the holder lever and rotates in conjunction with the holder lever, and is disengaged from the rotor when the sliding members move toward the holder lever; and
a biasing member pressing the second sleeve toward the rotor so as to engage the second sleeve with the rotor, the biasing member applying a force in a circumferential direction of the second sleeve or the holder lever,
wherein the body comprises a region that serves both as a stopper against an end portion of the biasing member and as a contact portion for restricting the second sleeve or the holder lever from moving in a rotation direction.

5. The cylinder lock device according to claim 4, wherein the region comprises a protrusion on the body.

6. The cylinder lock device according to claim 4, wherein the rotor is engaged with the second sleeve so as to rotate the holder lever according to a rotation of a correct key when the correct key is inserted into the key insertion hole.

7. The cylinder lock device according to claim 4, wherein the first sleeve allows disengagement between the rotor and the second sleeve so as not to rotate the holder lever according to a rotation of an incorrect key when the incorrect key is inserted into the key insertion hole.
